(19) United States
(12) Patent Application Publication
(10) Pub. No.: US 2020/0048396 A1
(43) Pub. Date: Feb. 13, 2020

(54) PROCESS FOR PRODUCING POLYURETHANES EXHIBITING LOW BLOOMING EFFECTS AND GOOD LOW-TEMPERATURE FLEXIBILITY ON THE BASIS OF URETHANE-CONTAINING POLYMERIC HYDROXYL COMPOUNDS

(71) Applicant: BASF SE, Ludwigshafen am Rhein (DE)

(72) Inventors: Sebastian RICHTER, Lemfoerde (DE); Frank SCHAEFER, Lemfoerde (DE); Johannes POPPENBERG, Wyandotte, MI (US); Hendrik WAGNER, Lemfoerde (DE)

(73) Assignee: BASF SE, Ludwigshafen am Rhein (DE)

(21) Appl. No.: 16/484,658

(22) PCT Filed: Mar. 20, 2018
(86) PCT No.: PCT/EP2018/057018

§ 371 Date: Aug. 8, 2019

(30) Foreign Application Priority Data
Mar. 21, 2017 (EP) 17162042.0

(51) Int. Cl. C08G 18/10; C08G 18/42; C08G 18/76; C08G 18/75; C08G 18/73; C08G 18/32

(52) U.S. Cl. CPC C08G 18/10; C08G 18/4238; C08G 18/7671; C08G 18/3203; C08G 18/757; C08G 18/73; C08G 18/7621

(57) ABSTRACT

The present invention relates to a process for producing a polyurethane, comprising the reaction of a polyol composition (PZ) comprising a polyol (P1) with a polyisocyanate composition (PIZ-1) comprising a polyisocyanate (I1) to obtain a hydroxyl-terminated prepolymer (PP1) and the reaction of the prepolymer (PP1) obtained with a polyisocyanate composition (PIZ-2) comprising a polyisocyanate (I2) and at least one chain extender (K1) to obtain a polyurethane (PU1), wherein the molar ratio of the OH groups in the components of the polyol composition (PZ) to the isocyanate groups in the components of the polyisocyanate composition (PIZ-1) in the reaction in step (i) is in the range from 1.3:1 to 10:1. The present invention further relates to polyurethanes obtainable or obtained by such a process, and to the use of the polyurethanes for production of shaped bodies, adhesives, coatings, hoses, films, nonwoven articles or fibers.

The present invention relates to a process for producing a polyurethane, comprising the reaction of a polyol composition (PZ) comprising a polyol (P1) with a polyisocyanate composition (PIZ-1) comprising a polyisocyanate (I1) to obtain a hydroxyl-terminated prepolymer (PP1) and the reaction of the prepolymer (PP1) obtained with a polyisocyanate composition (PIZ-2) comprising a polyisocyanate (I2) and at least one chain extender (K1) to obtain a polyurethane (PU1), wherein the molar ratio of the OH groups in the components of the polyol composition (PZ) to the isocyanate groups in the components of the polyisocyanate composition (PIZ-1) in the reaction in step (i) is in the range from 1.3:1 to 10:1. The present invention further relates to polyurethanes obtainable or obtained by such a process, and to the use of the polyurethanes for production of shaped bodies, adhesives, coatings, hoses, films, nonwoven articles or fibers.

Processes for producing polyurethanes are already known from the prior art. A common occurrence in the case of polyurethanes based on polyester polyols having high molecular weights is blooming of ester macrocycles, which leads to unwanted material properties. This effect can be controlled only with difficulty. The prior art discloses various strategies for reducing blooming effects. There are many descriptions of the use of chain termination reagents or the use of particular polyester polyols based on propylene glycols for reduction of the blooming effects.

For instance, WO15/000722 A1 discloses polyurethanes based on at least one polyisocyanate and at least one polyester polyol, where the polyester polyol is based on at least one polyhydric alcohol and a mixture of at least two dicarboxylic acids, where at least one of the at least two dicarboxylic acids has been obtained at least partly from renewable raw materials, and to processes for producing such polyurethanes and shaped bodies comprising such polyurethanes. The polyurethanes of the invention show a low tendency to blooming.

EP 0687695 A1 relates to the controlled reduction of the blooming effect by addition of a monofunctional alcohol for thermoplastic polyurethanes based on polyester polyols.

U.S. Pat. No. 8,790,763 discloses the reduction of blooming by the use of a polyester polyol with 1,3-propylene glycol as repeat unit.

WO 2012/173911 A1 describes the production of thermoplastic polyurethanes having reduced blooming by the use of polyester polyols with biobased glycols.

US 2003/0036621 relates to the reduction of blooming in the case of thermoplastic polyurethanes by chain termination additions such as monofunctional alcohols (with chain length >C14, monoisocyanates or monoamines).

WO 2009/103767 A1 discloses the production of thermoplastic polyurethanes having reduced deposit formation by the use of various mixtures of alkanediols as chain extender.

WO 2008/116801 A1 discloses the production of thermoplastic polyurethanes in a two-stage prepolymer mode. By contrast with the TPU described in accordance with the invention, the PU prepolymers are NCO-terminated.

However, the processes known from the prior art frequently lead to polyurethanes that do have a reduced tendency to blooming but do not have sufficiently good mechanical properties.

It was therefore an object of the present invention to provide a process by which polyurethanes having a reduced tendency to blooming are obtained, where the mechanical properties should be sufficiently good.

This object is achieved in accordance with the invention by a process for producing a polyurethane, comprising steps (i) and (ii)
(i) reacting a polyol composition (PZ) comprising a polyol (P1) with a polyisocyanate composition (PIZ-1) comprising a polyisocyanate (I1) to obtain a hydroxyl-terminated prepolymer (PP1);
(ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1.

It has been found that, surprisingly, the process of the invention can significantly reduce the tendency to blooming in polyurethanes based on polyester polyols having high molecular weights, for example with an MW>1500 g/mol, with retention of good cold flexibility.

The process of the invention comprises at least steps (i) and (ii) and may comprise further steps. In step (i), a polyol composition (PZ) comprising a polyol (P1) is reacted with a polyisocyanate composition (PIZ-1) comprising a polyisocyanate (I1) to obtain a hydroxyl-terminated prepolymer (PP1). The prepolymer (PP1) obtained in step (i) is reacted in step (ii) with a polyisocyanate composition (PIZ-2) comprising a polyisocyanate (I2) and at least one chain extender (K1) to obtain a polyurethane (PU1). According to the invention, the molar ratio of the OH groups in the components of the polyol composition (PZ) to the isocyanate groups in the components of the polyisocyanate composition (PIZ-1) in the reaction in step (i) is in the range from 1.3:1 to 10:1.

According to the invention, the process is run in such a way that polyisocyanate composition (PIZ-1) is first used in the reaction in step (i) and the isocyanate is converted essentially fully to obtain the prepolymer (PP1). In the context of the present invention, “converted essentially fully” is understood to mean that more than 99% of isocyanate groups present in the polyisocyanate composition (PIZ-1) are converted, preferably more than 99.5%, further preferably more than 99.9%, especially preferably more than 99.99%, of isocyanate groups present in the polyisocyanate composition (PIZ-1). According to the invention, it is possible that there are further steps between steps (i) and (ii) of the process of the invention, for example separation or purification steps. However, it is also possible in the context of the present invention that step (ii) is conducted directly after step (i) of the process of the invention.

According to the invention, the polyol composition (PZ) comprising a polyol (P1) is reacted with the polyisocyanate composition (PIZ-1) comprising a polyisocyanate (I1). The polyol composition (PZ) comprises at least one polyol (P1) and may comprise further polyols or further components, for example solvents. According to the invention, the polyisocyanate composition (PIZ-1) comprises at least one polyisocyanate (I1) and may comprise further polyisocyanates or further components, for example solvents. According to the invention, the polyisocyanate composition (PIZ-2) comprises at least one polyisocyanate (I2) and may comprise further polyisocyanates or further components, for example solvents.

According to the invention, a polyurethane is obtained. The polyurethane obtained in accordance with the invention is, for example, a thermoplastic polyurethane or a cast elastomer. In a further embodiment, the present invention therefore also relates to a process for producing a polyurethane as described above, wherein the polyurethane is thermoplastic.

The reaction in step (i) affords a hydroxyl-terminated prepolymer (PP1). In the context of the present invention, a hydroxyl-terminated prepolymer is understood to mean that the predominant proportion, for example more than 80%, preferably more than 90%, more preferably more than 99%, of the end groups present is hydroxyl end groups. Any remaining end groups are isocyanate end groups.

According to the invention, it is possible that the prepolymer (PP1) is isolated after step (ii). However, it is likewise possible that the prepolymer (PP1) is not isolated but directly converted further.

In step (ii), the prepolymer (PP1) obtained in step (i) is reacted with a polyisocyanate composition (PIZ-2) comprising a polyisocyanate (I2) and at least one chain extender (K1) to obtain a polyurethane (PU1).

In step (i) of the process of the invention, a polyol composition (PZ) comprising at least one polyol (P1) is used. Suitable polyols are known per se to those skilled in the art. Suitable polyols are described, for example, in “Kunststoffhandbuch [Plastics Handbook], volume 7, Polyurethane [Polyurethanes]”, Carl Hanser Verlag, 3rd edition 1993, chapter 3.1. Particular preference is given to using polyesterols or polyetherols as polyols. It is likewise possible to use polycarbonates. Copolymers may also be used in the context of the present invention. The number-average molecular weight of the polyols used in accordance with the invention is preferably between 0.5×10³ g/mol and 8×10³ g/mol, preferably between 0.6×10³ g/mol and 5×10³ g/mol, especially between 0.8×10³ g/mol and 3×10³ g/mol.

Polyetherols are suitable in accordance with the invention, but so are polyesterols, block copolymers and hybrid polyols, for example poly(ester/amide) or poly(ester/ether). According to the invention, preferred polyols are polytetramethylene ether glycol, polyethylene glycols, polypropylene glycols, polyadipates, polycarbonates, polycarbonate diols and polycaprolactone. According to the invention, particularly preferred polyols are polyadipates. According to the invention, very particularly preferred polyols are homopolyadipates.

In another embodiment, the present invention also relates to a composition as described above, wherein the polyol composition comprises a polyol selected from the group consisting of polyethers, polyesters, polycaprolactones and polycarbonates. Preferably in accordance with the invention, the polyol (P1) is selected from the group consisting of polyester polyols and polyether polyols, more preferably from polyester polyols, most preferably selected from linear polyester polyols.

Suitable polyols are for example polyetherols such as polydimethylene oxides, polytrimethylene oxides or polytetramethylene oxides.

Suitable block copolymers are for example those having ether and ester blocks, for example polycaprolactone having polyethylene oxide or polypropylene oxide end blocks, or polyethers having polycaprolactone end blocks. According to the invention, preferred polyetherols are polyethylene glycols and polypropylene glycols. Polycaprolactone is also preferred.

Suitable polyester polyols, especially polyester diols, may be prepared, for example, from dicarboxylic acids having 2 to 12 carbon atoms, preferably 4 to 10 carbon atoms, and polyhydric alcohols. Examples of useful dicarboxylic acids include: aliphatic dicarboxylic acids, such as succinic acid, glutaric acid, adipic acid, suberic acid, azelaic acid and sebacic acid, or aromatic dicarboxylic acids, such as phthalic acid, isophthalic acid and terephthalic acid. The dicarboxylic acids may be used individually or in the form of mixtures, for example in the form of a mixture of succinic acid, sebacic acid and adipic acid. For preparation of the polyester diols, it may possibly be advantageous to use, rather than the dicarboxylic acids, the corresponding dicarboxylic acid derivatives such as carboxylic diesters having 1 to 4 carbon atoms in the alcohol radical, for example dimethyl terephthalate or dimethyl adipate, carboxylic anhydrides, for example succinic anhydride, glutaric anhydride or phthalic anhydride, or carbonyl chlorides. Examples of polyhydric alcohols are glycols having 2 to 10, preferably 2 to 6, carbon atoms, for example ethylene glycol, diethylene glycol, butane-1,4-diol, pentane-1,5-diol, hexane-1,6-diol, decane-1,10-diol, 2,2-dimethylpropane-1,3-diol, propane-1,3-diol, 2-methylpropane-1,3-diol, 3-methylpentane-1,5-diol or dipropylene glycol. The polyhydric alcohols may be used individually or as mixtures, for example in the form of a butane-1,4-diol and/or propane-1,3-diol mixture. In addition, it is also possible to include small amounts of up to 3% by weight of the total reaction mixture of higher-functionality polyols of low molecular weight, for example 1,1,1-trimethylolpropane or pentaerythritol. Preference is given in accordance with the invention to the use of exclusively bifunctional starting compounds, i.e. polymer diol and diisocyanate.

When dimethyl esters of the dicarboxylic acids are used, for example, in the preparation of the preferred polyester polyols, it may likewise be the case as a result of transesterification being not entirely complete that small amounts of unconverted methyl ester end groups reduce the functionality of the polyesters to below 2.0, for example to 1.95 or else to 1.90.

The polycondensation for production of the polyester polyols used with preference in accordance with the invention, more preferably polyester diols, is effected by processes known to those skilled in the art, for example by first driving out the water of reaction at temperatures of 150 to 270° C. at standard pressure or slightly reduced pressure and lowering the pressure gradually later on, for example to 5 to 20 mbar. A catalyst is not required in principle, but is preferably added. Useful examples include tin(II) salts, titanium(IV) compounds, bismuth(III) salts and others for the purpose.

The molecular weight of the polyol composition (PZ) used or of the polyol (P1) used may vary within wide ranges. Suitable examples include polyol compositions (PZ) that have an average molecular weight in the range from 500 to 1500 g/mol, further preferably in the range from 600 to 1200 g/mol.

In a further embodiment, the present invention therefore also relates to a process for producing a polyurethane as described above, wherein the totality of the components of the polyol composition (PZ) has an average molecular weight in the range from 500 to 1500 g/mol. Unless stated otherwise, the values reported in the present application are number-average molecular weights.

In a further preferred embodiment, the polyol (P1) used has a number-average molecular weight Mn in the range from 500 g/mol to 1500 g/mol, preferably in the range from 600 g/mol to 1200 g/mol.

It is also possible in accordance with the invention to use mixtures of different polyols. The polyols used or the polyol composition preferably have an average functionality in the range from 1.7 and 2.3, preferably in the range from 1.9 and 2.1, especially 2. The polyols used in accordance with the invention preferably have solely primary hydroxyl groups.

In a further embodiment, the present invention therefore also relates to a process for producing a polyurethane as described above, wherein the totality of the components of the polyol composition (PZ) has an average functionality in the range from 1.7 to 2.3. In a further preferred embodiment, the polyol (P1) used has an average functionality in the range from 1.7 and 2.3, preferably in the range from 1.9 and 2.1, especially 2.

According to the invention, the polyol composition may also comprise a solvent. Suitable solvents are known per se to those skilled in the art.

According to the invention, in step (i), a polyisocyanate composition (PIZ-1) comprising a polyisocyanate (I1) is used. In step (ii), a polyisocyanate composition (PIZ-2) comprising a polyisocyanate (I2) is used. Preferred polyisocyanates within the context of the present invention are diisocyanates, especially aliphatic or aromatic diisocyanates.

In addition, in the context of the present invention, prereacted products are used as isocyanate components, in which a polyol is reacted with an isocyanate in a preceding reaction step. The products obtained have essentially isocyanate end groups and may be used in accordance with the invention as a component of the polyisocyanate composition.

Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylene dicyclohexyl 4,4′-, 2,4′- and/or 2,2′-diisocyanate (H12MDI).

Preferred aliphatic polyisocyanates are hexamethylene 1,6-diisocyanate (HDI), 1-isocyanato-3,3,5-trimethyl-5-isocyanatomethylcyclohexane and methylene dicyclohexyl 4,4′-, 2,4′- and/or 2,2′-diisocyanate (H12MDI).

Suitable aromatic diisocyanates are especially naphthylene 1,5-diisocyanate (NDI), tolylene 2,4- and/or 2,6-diisocyanate (TDI), diphenylmethane 2,2′-, 2,4′- and/or 4,4′-diisocyanate (MDI), 3,3′-dimethyl-4,4′-diisocyanatodiphenyl (TODI), p-phenylene diisocyanate (PDI), diphenylethane 4,4′-diisocyanate (EDI), diphenylmethane diisocyanate, 3,3′-dimethyldiphenyl diisocyanate, diphenylethane 1,2-diisocyanate and/or phenylene diisocyanate.

It is also possible in the context of the present invention to use higher-functionality isocyanates, by way of example triisocyanates, for example triphenylmethane 4,4′,4″-triisocyanate, and also the cyanurates of the aforementioned diisocyanates, and the oligomers obtainable by partial reaction of diisocyanates with water, for example the biurets of the aforementioned diisocyanates, and additionally oligomers obtainable by controlled reaction of semiblocked diisocyanates with polyols having an average of more than two and preferably three or more hydroxyl groups.

According to the invention, it is possible that different polyisocyanates are used in steps (i) and (ii). According to the invention, it is also possible that identical polyisocyanates are used in steps (i) and (ii).

In a preferred embodiment, the present invention relates to a process wherein the at least one first polyisocyanate and the at least one second polyisocyanate are different.

For example, the polyisocyanate (I1) may be selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) or naphthalene 1,5-diisocyanate (NDI).

In a further embodiment, the present invention therefore also relates to a process for producing a polyurethane as described above, wherein the polyisocyanate (I1) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) or naphthalene 1,5-diisocyanate (NDI). The polyisocyanate (I2) is preferably selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) and naphthalene 1,5-diisocyanate (NDI).

In a further embodiment, the present invention therefore also relates to a process for producing a polyurethane as described above, wherein the polyisocyanate (I2) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) and naphthalene 1,5-diisocyanate (NDI).

Preference is given in accordance with the invention to using aliphatic polyisocyanates as polyisocyanate (I1). Polyisocyanates (12) used are preferably aromatic polyisocyanates. In a further embodiment, the present invention therefore also relates to a process for producing a polyurethane as described above, wherein the polyisocyanate (I1) is selected from aliphatic polyisocyanates and the polyisocyanate (I2) is selected from aromatic polyisocyanates.

According to the invention, the polyisocyanate composition (PIZ-1) and/or (PIZ-2) may also comprise one or more solvents. Suitable solvents are known to those skilled in the art. Suitable examples are nonreactive solvents such as ethyl acetate, methyl ethyl ketone and hydrocarbons.

In step (i), the molar ratio of the OH groups in the components of the polyol composition (PZ) to the isocyanate groups in the components of the polyisocyanate composition (PIZ-1) in the reaction is in the range from 1.3:1 to 10:1. Preferably, the molar ratio of the OH groups in the components of the polyol composition (PZ) to the isocyanate groups in the components of the polyisocyanate composition (PIZ-1) in the reaction is in the range from 1.4:1 to 6.0:1. Most preferably, the molar ratio of the OH groups in the components of the polyol composition (PZ) to the isocyanate groups in the components of the polyisocyanate composition (PIZ-1) is in the range from 1.5:1 to 3.0:1.

According to the invention, the process is preferably run in such a way that the prepolymer (PP1) obtained in step (i) has an average molecular weight in the range from 800 to 5000 g/mol, further preferably in the range from 1200 to 3000 g/mol.

For example, the reaction in step (i) is run at a temperature of about 80° C. for a duration of 1 to 3 hours, for example 2 hours.

In a further embodiment, the present invention therefore also relates to a process for producing a polyurethane as described above, wherein the prepolymer (PP1) has an average molecular weight in the range from 800 to 5000 g/mol.

According to the invention, a chain extender (CE 1) is used in step (ii). Suitable chain extenders are known per se to those skilled in the art.

Chain extenders used are compounds having at least two groups reactive toward isocyanates. Groups reactive toward isocyanates may especially be NH, OH or else SH groups. Suitable examples are diamines or else diols or water. Preference is given to using at least one chain extender selected from the group consisting of compounds having at least two isocyanate-reactive groups having a molecular weight of <500 g/mol.

In a further embodiment, the present invention therefore also relates to a process for producing a polyurethane as described above, wherein the chain extender (K1) is selected from the group consisting of diols, diamines and/or water.

Chain extenders used may, for example, be commonly known aliphatic, araliphatic, aromatic and/or cycloaliphatic compounds having a molecular weight of 50 to 499 g/mol, preferably bifunctional compounds, for example alkanediols having 2 to 10 carbon atoms in the alkylene radical, for example diols selected from the group consisting of C2 to C6 diols, preferably butane-1,4-diol, hexane-1,6-diol and/or di-, tri-, tetra-, penta-, hexa-, hepta-, octa-, nona- and/or decaalkylene glycols having 3 to 8 carbon atoms, preferably unbranched alkanediols, especially propane-1,3-diol, butane-1,4-diol and hexane-1,6-diol.

It is further preferably possible here to use aliphatic, araliphatic, aromatic and/or cycloaliphatic diols having a molecular weight of 50 g/mol to 220 g/mol. Preference is given to alkanediols having 2 to 12 carbon atoms in the alkylene radical, especially di-, tri-, tetra-, penta-, hexa-, hepta-, octa-, nona- and/or decaalkylene glycols. For the present invention, particular preference is given to 1,2-ethylene glycol, propane-1,3-diol, butane-1,4-diol and hexane-1,6-diol.

Also suitable as chain extenders within the context of the present invention are branched compounds such as cyclohexane-1,4-dimethanol, 2-butyl-2-ethylpropanediol, neopentyl glycol, 2,2,4-trimethylpentane-1,3-diol, pinacol, 2-ethylhexane-1,3-diol, cyclohexane-1,4-diol or N-phenyldiethanolamine. Compounds having OH and NH groups are also suitable, such as 4-aminobutanol for example.

It is also possible in accordance with the invention to use mixtures of two or more chain extenders.

Within the context of the present invention the employed amount of the chain extender and the polyol composition may be varied within broad ranges. For example, in the context of the present invention, the chain extender (CE) may be used in an amount in the range from 1:40 to 10:1, based on the prepolymer used.

The molecular weight of the polyurethane (PU1) of the invention which is obtained in step (ii) may vary within wide ranges. It is particularly advantageous for the polyurethane (PU1) to have a molecular weight in the range from 20 000 to 500 000 g/mol, determined by means of GPC, more preferably in the range from 50 000 to 200 000 g/mol. In a further embodiment, the present invention also relates to a composition as described above, wherein the polyurethane has a molecular weight in the range from 20 000 to 500 000 g/mol, determined by means of GPC.

According to the invention, further additives, for example catalysts or auxiliaries and additions, may be added in the course of reaction in steps (i) and (ii). Additives and auxiliaries are known per se to those skilled in the art. It is also possible in accordance with the invention to use combinations of two or more additives.

In the context of the present invention the term “additive” is more particularly understood to mean catalysts, auxiliaries and additives, especially stabilizers, nucleating agents, release agents, demolding aids, fillers, flame retardants or crosslinkers.

Suitable additives are for example stabilizers, nucleating agents, fillers, for example silicates, or crosslinkers, for example polyfunctional aluminosilicates.

Examples of auxiliaries and additives include surface-active substances, flame retardants, nucleating agents, oxidation stabilizers, antioxidants, lubricants and demolding aids, dyes and pigments, stabilizers, for example against hydrolysis, light, heat or discoloration, inorganic and/or organic fillers, reinforcers and plasticizers. Suitable auxiliaries and additives can be found, for example, in Kunststoffhandbuch, volume VII, edited by Vieweg and Hochtlen, Carl Hanser Verlag, Munich 1966 (p. 103-113).

Suitable catalysts are likewise known in principle from the prior art and especially relate to the reaction of nucleophiles with isocyanates. Suitable catalysts are for example organic metal compounds selected from the group consisting of tin organyls, titanium organyls, zirconium organyls, hafnium organyls, bismuth organyls, zinc organyls, aluminum organyls and iron organyls, for example tin organyl compounds, preferably tin dialkyls such as dimethyltin or diethyltin, or tin organyl compounds of aliphatic carboxylic acids, preferably tin diacetate, tin dilaurate, dibutyltin diacetate, dibutyltin dilaurate, bismuth compounds, such as bismuth alkyl compounds or the like, or iron compounds, preferably iron(MI) acetylacetonate, or the metal salts of carboxylic acids, for example tin(II) isooctoate, tin dioctoate, titanate esters or bismuth(III) neodecanoate.

In a preferred embodiment the catalysts are selected from tin compounds and bismuth compounds, more preferably tin alkyl compounds or bismuth alkyl compounds. Tin(II) isooctoate and bismuth neodecanoate are particularly suitable.

The catalysts are typically employed in amounts of 0 to 2000 ppm, preferably 1 ppm to 1000 ppm, more preferably 2 ppm to 500 ppm and most preferably of 5 ppm to 300 ppm.

Step (i) of the process of the invention can be conducted in apparatuses that are known per se to the person skilled in the art for preparation of prepolymers, for example heatable/coolable stirred tanks or reaction extruders. Step (i) of the process of the invention is conducted at temperatures known per se to the person skilled in the art, for example at a temperature in the range from 20 to 250° C., preferably in the range from 40 to 130° C., further preferably at a temperature in the range from 70 to 90° C.

In a further embodiment, the present invention therefore also relates to a process for producing a polyurethane as described above, wherein the reaction in step (i) is conducted at a temperature in the range from 40 to 130° C.

Step (i) of the process of the invention can be conducted in the presence of at least one solvent, for example selected from the group of the inert solvents, i.e. solvents that do not have any reactive hydrogen atoms, preferably selected from the group consisting of toluene, dimethylformamide, tetrahydrofuran etc. and mixtures thereof, or in the absence of a solvent.

Step (ii) of the process of the invention can generally be conducted at any temperature known to those skilled in the art, for example at a temperature in the range from 20 to 250° C., preferably in the range from 40 to 230° C. Therefore, the present invention also relates to a process as described above, wherein step (ii) is effected at a temperature in the range from 40 to 230° C.

According to the invention, it is possible that the prepolymer (PP1) is not isolated after step (i) and is used directly in step (ii). According to the invention, it is possible here to conduct steps (i) and (ii) in one apparatus, meaning that firstly the reaction in step (i) is effected, and then the reaction in step (ii) is effected.

According to the invention, it is also possible for the process to comprise further steps, for example a pretreatment of the components or an aftertreatment of the thermoplastic polyurethane obtained, for example a heat treatment. Accordingly, in a further embodiment, the present invention also relates to a process for producing a thermoplastic polyurethane as described above, wherein the thermoplastic polyurethane obtained is heat-treated after the reaction.

The present invention therefore also relates to a polyurethane obtainable or obtained by the process of the invention.

In a further aspect, the present invention therefore also relates to a polyurethane obtainable or obtained by processes comprising steps (i) and (ii):
(i) reacting a polyol composition (PZ) comprising a polyol (P1) with a polyisocyanate composition (PIZ-1) comprising a polyisocyanate (I1) to obtain a hydroxyl-terminated prepolymer (PP1);
(ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1.

With regard to the preferred embodiments, reference is made to the above statements relating to the process of the invention. In a further embodiment, the present invention therefore also relates to a polyurethane as described above, wherein the polyurethane is thermoplastic.

In a further embodiment, the present invention therefore also relates to a polyurethane as described above, wherein the prepolymer (PP1) has an average molecular weight in the range from 800 to 5000 g/mol.

The present invention of one embodiment also further relates to a polyurethane as described above, wherein the polyisocyanate (I1) is selected from aliphatic polyisocyanates and the polyisocyanate (I2) is selected from aromatic polyisocyanates.

The polyurethane of the invention and the polyurethane obtained or obtainable by a process of the invention can be processed further by processes known to the person skilled in the art to give the desired films, moldings, rolls, fibers, automobile trim, hoses, cable connectors, bellows, trailing cables, cable sheets, gaskets, belts or damping elements, for example injection molding, calendering or extrusion.

The polyurethane produced in accordance with the invention may advantageously be used especially in all applications specific to thermoplastic polyurethanes. The present invention therefore also relates to the use of a polyurethane obtainable or obtained by a process as described above or of a polyurethane as described above for production of shaped bodies, adhesives, coatings, hoses, films, nonwoven articles or fibers.

Further embodiments of the present invention are apparent from the claims and the examples. It will be appreciated that the features of the object/processes/uses according to the invention that are mentioned above and elucidated below are usable not only in the combination specified in each case but also in other combinations without departing from the scope of the invention. Thus, for example, the combination of a preferred feature with a particularly preferred feature or of a feature not characterized further with a particularly preferred feature etc. is also encompassed implicitly even if this combination is not mentioned explicitly.

The present invention is illustrated in more detail by the following embodiments and combinations of embodiments which are apparent from the corresponding dependency references and other references. In particular, it should be noted that in every case where a range of embodiments is mentioned, for example in the context of an expression such as “the process according to any of embodiments 1 to 4”, each embodiment in this range is deemed to be explicitly disclosed to those skilled in the art, i.e. the wording of this expression is to be understood by those skilled in the art as synonymous with “the process according to any of embodiments 1, 2, 3 and 4”.
1. A process for producing a polyurethane, comprising steps (i) and (ii)
   (i) reacting a polyol composition (PZ) comprising a polyol (P1) with a polyisocyanate composition (PIZ-1) comprising a polyisocyanate (I1) to obtain a hydroxyl-terminated prepolymer (PP1);
   (ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1.
2. The process according to embodiment 1, wherein the totality of the components of the polyol composition (PZ) has an average molecular weight in the range from 500 to 1500 g/mol.
3. The process according to embodiment 1 or 2, wherein the totality of the components of the polyol composition (PZ) has an average functionality in the range from 1.7 to 2.3.
4. The process according to any of embodiments 1 to 3, wherein the polyurethane is thermoplastic.
5. The process according to any of embodiments 1 to 4, wherein the prepolymer (PP1) has an average molecular weight in the range from 800 to 5000 g/mol.
6. The process according to any of embodiments 1 to 5, wherein the polyisocyanate (I1) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) or naphthalene 1,5-diisocyanate (NDI).
7. The process according to any of embodiments 1 to 6, wherein the polyisocyanate (I2) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) and naphthalene 1,5-diisocyanate (NDI).
8. The process according to any of embodiments 1 to 7, wherein the polyisocyanate (I1) is selected from aliphatic polyisocyanates and the polyisocyanate (I2) is selected from aromatic polyisocyanates.
9. The process according to any of embodiments 1 to 8, wherein the chain extender (K1) is selected from the group consisting of diols, diamines and/or water.
10. The process according to any of embodiments 1 to 9, wherein the reaction in step (i) is conducted at a temperature in the range from 40 to 130° C.
11. A process for producing a polyurethane, comprising steps (i) and (ii)
   (i) reacting a polyol composition (PZ) comprising a polyol (P1) with a polyisocyanate composition (PIZ-1) comprising a polyisocyanate (I1) to obtain a hydroxyl-terminated prepolymer (PP1);
   (ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1,
   wherein the totality of the components of the polyol composition (PZ) has an average molecular weight in the range from 500 to 1500 g/mol and
   wherein the totality of the components of the polyol composition (PZ) has an average functionality in the range from 1.7 to 2.3.
12. A process for producing a polyurethane, comprising steps (i) and (ii)
   (i) reacting a polyol composition (PZ) comprising a polyol (P1) with a polyisocyanate composition (PIZ-1) comprising a polyisocyanate (I1) to obtain a hydroxyl-terminated prepolymer (PP1);
   (ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1 and
   wherein the reaction in step (i) is conducted at a temperature in the range from 40 to 130° C.
13. A process for producing a polyurethane, comprising steps (i) and (ii)
   (i) reacting a polyol composition (PZ) comprising a polyol (P1) with a polyisocyanate composition (PIZ-1) comprising a polyisocyanate (I1) to obtain a hydroxyl-terminated prepolymer (PP1);
   (ii) reacting the prepolymer (PP1) obtained in step (i) with a polyisocyanate composition

(PIZ-2) comprising a polyisocyanate (I2) and at least one chain extender (K1) to obtain a polyurethane (PU1), wherein the molar ratio of the OH groups in the components of the polyol composition (PZ) to the isocyanate groups in the components of the polyisocyanate composition (PIZ-1) in the reaction in step (i) is in the range from 1.3:1 to 10:1, and wherein the prepolymer (PP1) has an average molecular weight in the range from 800 to 5000 g/mol.
14. A process for producing a polyurethane, comprising steps (i) and (ii)
   (i) reacting a polyol composition (PZ) comprising a polyol (P1) with a polyisocyanate composition (PIZ-1) comprising a polyisocyanate (I1) to obtain a hydroxyl-terminated prepolymer (PP1);
   (ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1, and
   wherein the polyisocyanate (I1) is selected from aliphatic polyisocyanates and the polyisocyanate (I2) is selected from aromatic polyisocyanates.
15. A polyurethane obtainable or obtained by processes comprising steps (i) and (ii):
   (i) reacting a polyol composition (PZ) comprising a polyol (P1) with a polyisocyanate composition (PIZ-1) comprising a polyisocyanate (I1) to obtain a hydroxyl-terminated prepolymer (PP1);
   (ii) reacting the prepolymer (PP1) obtained in step (i) with a polyisocyanate composition (PIZ-2) comprising a polyisocyanate (I2) and at least one chain extender (K1) to obtain a polyurethane (PU1),
   wherein the molar ratio of the OH groups in the components of the polyol composition (PZ) to the isocyanate groups in the components of the polyisocyanate composition (PIZ-1) in the reaction in step (i) is in the range from 1.3:1 to 10:1.
16. The polyurethane according to embodiment 15, wherein the prepolymer (PP1) has an average molecular weight in the range from 800 to 5000 g/mol.
17. The polyurethane according to embodiment 15 or 16, wherein the polyisocyanate (I1) is selected from aliphatic polyisocyanates and the polyisocyanate (I2) is selected from aromatic polyisocyanates.
18. The polyurethane according to any of embodiments 15 to 17, wherein the polyurethane is thermoplastic.
19. The polyurethane according to any of embodiments 15 to 18, wherein the totality of the components of the polyol composition (PZ) has an average molecular weight in the range from 500 to 1500 g/mol.
20. The polyurethane according to any of embodiments 15 to 19, wherein the totality of the components of the polyol composition (PZ) has an average functionality in the range from 1.7 to 2.3.
21. The polyurethane according to any of embodiments 15 to 20, wherein the prepolymer (PP1) has an average molecular weight in the range from 800 to 5000 g/mol.
22. The polyurethane according to any of embodiments 15 to 21, wherein the polyisocyanate (I1) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) or naphthalene 1,5-diisocyanate (NDI).
23. The polyurethane according to any of embodiments 15 to 22, wherein the polyisocyanate (12) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) and naphthalene 1,5-diisocyanate (NDI).
24. The polyurethane according to any of embodiments 15 to 23, wherein the polyisocyanate (I1) is selected from aliphatic polyisocyanates and the polyisocyanate (I2) is selected from aromatic polyisocyanates.
25. The polyurethane according to any of embodiments 15 to 24, wherein the chain extender (K1) is selected from the group consisting of diols, diamines and/or water.
26. The polyurethane according to any of embodiments 15 to 25, wherein the reaction in step (i) is conducted at a temperature in the range from 40 to 130° C.
27. The use of a polyurethane obtainable or obtained by a process according to any of embodiments 1 to 14 or of a polyurethane according to any of embodiments 15 to 26 for production of shaped bodies, adhesives, coatings, hoses, films, nonwoven articles or fibers.

### BRIEF DESCRIPTION OF THE FIGURES

FIG. 1 shows images of scanned test banks by way of illustrative overview of the visual assessment of blooming. Image 1a shows the comparative example comparative 1 at time t=0 weeks; image 1b shows the comparative example comparative 1 at time t=4 weeks; image 2a shows the comparative example comparative 2 at time t=0 weeks; image 2b shows the comparative example comparative 2 at time t=4 weeks; image 3a shows inventive example 1 at time t=0 weeks; image 3 shows inventive example 1 at time t=4 weeks; image 4a shows inventive example 2 at time t=0 weeks; image 4b shows inventive example 2 at time t=4 weeks.

FIG. 2 shows results of dynamic-mechanical analyses (DMA measurements). 2a shows, by way of illustrative overview of the assessment of cold flexibility, the result of a DMA measurement of comparative 1, with the temperature in ° C. plotted on the x axis and the storage modulus in MPa on the y axis. Embrittlement is shown by the curve progression in the range from −20° C. to +20° C. 2b shows, by way of comparison, the result of a DMA measurement for example 1, with the temperature in ° C. plotted on the x axis and the storage modulus in MPa on the y axis. No embrittlement in the −20° C. to +20° C. range is observed.

The examples which follow are intended to illustrate the invention but are in no way intended to restrict the subject matter of the present invention.

### EXAMPLES

### 1. Measurement Methods

Viscosity determination: Unless stated otherwise, the viscosity of the polyols was determined at 75° C. to DIN EN ISO 3219 (Jan. 10, 1994 edition) with a Rheotec RC 20 rotary viscometer using the CC 25 DIN spindle (spindle diameter: 12.5 mm; internal measuring cylinder diameter: 13.56 mm) at a shear rate of 50 1/s.
Measurement of hydroxyl number: Hydroxyl numbers were determined by the phthalic anhydride method DIN 53240 (Jan. 12, 1971 edition) and reported in mg KOH/g.
Measurement of acid number: Acid number was determined to DIN EN 1241 (Jan. 5, 1998 edition) and is reported in mg KOH/g.
Determination of molecular weight: In accordance with the prior art, the molecular weight was ascertained according to DIN55672-2. In this case calibration was performed using PMMA.
NCO value determination: Determination of the NCO content was conducted according to EN ISO 11909: primary and secondary amines react with isocyanates to give substituted ureas. This reaction proceeded quantitatively in an excess of amine. At the end of the reaction the excess amine is subjected to potentiometric back-titration with hydrochloric acid.
Dynamic-mechanical analysis: Dynamic-mechanical analysis (DMA) was effected in accordance with DIN EN ISO 6721-1 to -7 and the evaluation in accordance with ASTM D 4065-99

### 2. Feedstocks

| | |
|---|---|
| Isocyanate 1 | is hexamethylene 1,6-diisocyanate (HDI), molar mass 168.20 g/mol |
| Isocyanate 2 | is diphenylmethane 4,4′-diisocyanate (4,4′-MDI), molar mass 250.26 g/mol |
| Isocyanate 3 | is tolylene 2,4- and 2,6-diisocyanate in a ratio of 80:20 (TDI 80) |
| Isocyanate 4 | 1-isocyanato-4-[(4-isocyanatocyclohexyl)methyl]cyclohexane (H12MDI) |
| Polymer polyol 1: | polyester diol having OH number about 45, formed from adipic acid and |
| | butane-1,4-diol (MW: about 2500) |
| Polymer polyol 2: | polyester diol having OH number about 150, formed from adipic acid and |
| | butane-1,4-diol (MW: about 900) |
| Polymer polyol 3: | polyester diol having OH number about 112, formed from adipic acid and |
| | butane-1,4-diol (MW: about 1000) |
| Polymer polyol 4: | HDI-modified polymer polyol 2 having an OH number of about 64 |
| | (OH:NCO = 4:2; MW: about 1800) |
| Polymer polyol 5: | HDI-modified polymer polyol 2 having an OH number of about 55 |
| | (OH:NCO = 3.5:2; MW: about 2000) |
| Polymer polyol 6: | HDI-modified polymer polyol 2 having an OH number of about 40 |
| | (OH:NCO = 3:2; MW: about 2500) |
| Polymer polyol 7: | HDI-modified polymer polyol 2 having an OH number of about 125 |
| | (OH:NCO = 10:1; MW: about 950) |
| Polymer polyol 8: | HDI-modified polymer polyol 3 having an OH number of about 51 |
| | (OH:NCO = 4:2; MW: about 2200) |
| Polymer polyol 9: | HDI-modified polymer polyol 3 having an OH number of about 44 |
| | (OH:NCO = 3.5:2; MW: about 2600) |
| Polymer polyol 10: | HDI-modified polymer polyol 3 having an OH number of about 33 |
| | (OH:NCO = 3:2; MW: about 3500) |
| Polymer polyol 11: | H12MDI-modified polymer polyol 2 having an OH number of about 65 |
| | (OH:NCO = 4:2; MW: about 1800) |
| Polymer polyol 12: | 4,4′-MDI-modified polymer polyol 2 having an OH number of about 60 |
| | (OH:NCO = 4:2; MW: about 1900) |
| Polymer polyol 13: | 4,4′-MDI-modified polymer polyol 2 having an OH number of about 124 |
| | (OH:NCO = 10:1; MW: about 1000) |
| Polymer polyol 14: | TDI 80-modified polymer polyol 2 having an OH number of about 65 |
| | (OH:NCO = 4:2; MW: about 1800) |
| Polymer polyol 15 | polytetrahydrofuran (pTHF; polytetramethylene ether glycol, PTMEG) |
| | having an OH number of about 56 (MW: about 2000) |
| Polymer polyol 16 | polytetrahydrofuran (pTHF; polytetramethylene ether glycol, PTMEG) |
| | having an OH number of about 112 (MW: about 1000) |
| Polymer polyol 17: | HDI-modified polymer polyol 16 having an OH number of about 53 |
| | (OH:NCO = 4:2; MW: about 2000) |
| Catalyst 1 | TIB KAT ® from TIB Chemicals AG |
| Chain extender 1: | is butane-1,4-diol, molar mass 90.12 g/mol |
| Hydrolysis stabilizer 1: | is a carbodiimide-based hydrolysis stabilizer (Elastostab ® H01) |

### 3. Production Examples

### 3.1 General Processing Method 1

Polymer polyol is initially charged at 50° C. in a 4000 ml round-neck flask fitted with a PT100 thermocouple, nitrogen feed, stirrer and heating mantle, and isocyanate is added at that temperature. The reaction mixture is heated to 70-80° C. and catalyst 1 is added if appropriate. The reaction mixture is heated at 80° C. for 2 hours, then allowed to come to room temperature and used without further treatment for the production of a polyurethane by general processing method 2.

### 3.2 General Processing Method 2

The respective polymer polyol is reacted together with chain extender 1 and isocyanate. Hydrolysis stabilizer 1 is added to the reaction mixture if appropriate. The resulting reaction mixture is poured out onto a heatable Teflon-coated table and reacted to completion at 120° C. for 10 minutes. The polymer sheet thus obtained is then heat-treated at 80° C. for 15 hours and subsequently pelletized. The pellets are shaped to a test sheet by the injection molding method.

### 4. Comparative Examples

### 4.1 Comparisons 1, 2 and 5

General processing method 2 is used to convert polymer polyol 1, 2 or 15, chain extender 1 and isocyanate 2. The results are summarized in table 1.

### 4.2 Comparisons 3 and 4

General processing method 2 is used to convert polymer polyol 1 or 2, chain extender 1 and a mixture of isocyanate 1 with 2. The results are summarized in table 1.

TABLE 1
Comparative compounds used.

| | Comparison 1 | Comparison 2 | Comparison 3 | Comparison 4 | Comparison 5 |
|---|---|---|---|---|---|
| Polymer polyol 1 [g] | 1000 | | | | |
| Polymer polyol 2 [g] | | 840 | 528 | 905 | |
| Polymer polyol 15 [g] | | | | | 980 |
| Chain extender 1 [g] | 103 | 104 | 204 | 102 | 103 |
| Isocyanate 1 [g] | | | 12.5 | 95.0 | |
| Isocyanate 2 [g] | 384 | 557 | 780 | 390 | 413 |
| Stabilizer 1 [g] | 7.4 | 7.5 | 4.5 | 7.3 | 7.8 |
| Index | 1000 | 1000 | 1000 | 1000 | 1000 |
| Starting temperature | 80° C. | 80° C. | 80° C. | 80° C. | 80° C. |
| Casting temperature | 110° C. | 110° C. | 110° C. | 110° C. | 110° C. |

### 5. Inventive Examples

It has been found that, surprisingly, the use of isocyanate-preextended polyester polyols based on polyester polyols of relatively low molecular weight, preferably having a molecular weight <1000 enables production of novel urethane-containing polyester polyol structures that lead to a distinct reduction in blooming in the corresponding polyurethane.

For this purpose, isocyanate-containing polyester polyols were first prepared by general processing method 1. Subsequently, the compact polyurethanes were produced by general processing method 2.

### 5.1 Example 1—(Inventive)

Processing method 1 is used to convert polymer polyols of type 2/3, isocyanates of type 1-4 and 0.002% by weight of catalyst 1.

Processing method 2 is used to convert polymer polyol 4-14, chain extender 1 and isocyanate 1-4. The results are summarized in table 2.

TABLE 2a
Example compounds used in accordance with the invention.

| | Example 1 | Example 2 | Example 3 | Example 4 | Example 5 | Example 6 |
|---|---|---|---|---|---|---|
| Polymer polyol 4 [g] | 950 | | | | | |
| Polymer polyol 5 [g] | | 950 | | | | |
| Polymer polyol 6 [g] | | | 1000 | | | |
| Polymer polyol 7 [g] | | | | 850 | | |
| Polymer polyol 8 [g] | | | | | 1000 | |
| Polymer polyol 9 [g] | | | | | | 1000 |
| Chain extender 1 [g] | 102 | 100 | 103 | 102 | 104 | 103 |
| Isocyanate 2 [g] | 421 | 399 | 383 | 522 | 408 | 387 |
| Stabilizer 1 [g] | 7.6 | 8.0 | 6.8 | 8.0 | 8.0 | 8.0 |
| Index | 1000 | 1000 | 1000 | 1000 | 1000 | 1000 |
| Hard segment content | 26.2% | 26.2% | 26.2% | 26.2% | 26.2% | 26.2% |
| Starting temperature | 80° C. | 80° C. | 80° C. | 80° C. | 80° C. | 80° C. |
| Casting temperature | 110° C. | 110° C. | 110° C. | 110° C. | 110° C. | 110° C. |

TABLE 2b
Example compounds used in accordance with the invention.

| | Example 7 | Example 8 | Example 9 | Example 10 | Example 11 |
|---|---|---|---|---|---|
| Polymer polyol 10 [g] | 1000 | | | | |
| Polymer polyol 11 [g] | | 950 | | | |
| Polymer polyol 12 [g] | | | 1000 | | |
| Polymer polyol 13 [g] | | | | 850 | |
| Polymer polyol 14 [g] | | | | | 950 |
| Chain extender 1 [g] | 101 | 102 | 135 | 102 | 102 |
| Isocyanate 1 [g] | | | 342 | | |
| Isocyanate 2 [g] | 356 | 425 | | 520 | 426 |
| Stabilizer 1 [g] | 8.0 | 7.6 | 8.0 | 6.8 | 7.6 |
| Index | 1000 | 1000 | 1000 | 1000 | 1000 |
| Hard segment content | 26.2% | 26.2% | 26.2% | 26.2% | 26.2% |
| Starting temperature | 80° C. | 80° C. | 80° C. | 80° C. | 80° C. |
| Casting temperature | 110° C. | 110° C. | 110° C. | 110° C. | 110° C. |

TABLE 2c
Example compounds used in accordance with the invention.

| | Example 12 |
|---|---|
| Polymer polyol 17 [g] | 980 |
| Chain extender 1 [g] | 103 |
| Isocyanate 2 [g] | 405 |
| Stabilizer 1 [g] | 7.8 |
| Index | 1000 |
| Hard segment content | 26.2% |
| Starting temperature | 80° C. |
| Casting temperature | 110° C. |

### 6. Mechanical Properties of the Test Specimens, Material Properties and Tendency to Blooming

The measurements collated in the tables which follow were established from injection-molded sheets of comparisons 1 to 4 and examples 1 to 11.

The following properties of the obtained polyurethanes were determined by the mentioned methods:
Density: DIN EN ISO 1183-1, A
Hardness (Shore ND): DIN ISO 7619-1
Tensile strength: DIN 53504
Elongation at break: DIN 53504
Tear propagation resistance: DIN ISO 34-1, B (b)
Measurement of abrasion: DIN ISO 4649
Glass transition temperature: T_{g} was determined by differential scanning calorimetry.
Blooming: After storage of the test specimens at room temperature for a defined period of 4 weeks after production, the intensity of blooming is assessed visually.
Cold flexibility: The effect of embrittlement in the −20° C. to +20° C. range was ascertained by dynamic-mechanical analysis (DMA) and differential scanning calorimetry (DSC).

Table 3. Overview of the mechanical properties of the test specimens and the respective tendencies to blooming.

### a) Comparisons 1-4

| Mechanical testing | Comparison 1 | Comparison 2 | Comparison 3 | Comparison 4 | Comparison 5 |
|---|---|---|---|---|---|
| Density [g/cm³] | 1.193 | 1.216 | 1.243 | no | 1.086 |
| Shore hardness test [A | 84 (33) | 91 (48) | — (76) | hardening | 84 (33) |
| (D)] | | | | | |
| Tensile strength [MPa] | 50 | 59 | 56 | | 39 |
| Elongation at break | 680 | 520 | 320 | | 660 |
| [%] | | | | | |
| Tear propagation | 88 | 122 | 226 | | 45 |
| resistance [kN/m] | | | | | |
| Abrasion [mm³] | 35 | 34 | 43 | | 32 |
| T_{g} (DMA, max G″) [° C.] | −45 | −20 | 15 | | −65 |
| Blooming | yes | no | — | | — |
| Embrittlement at about | no | no | no | | yes |
| 0° C. | | | | | |

### b) Examples 1-4

| Mechanical testing | Example 1 | Example 2 | Example 3 | Example 4 |
|---|---|---|---|---|
| Density [g/cm³] | 1.199 | 1.198 | 1.195 | 1.213 |
| Shore hardness test | 86 (37) | 84 (36) | 82 (34) | 89 (45) |
| [A (D)] | | | | |
| Tensile strength [MPa] | 35 | 55 | 56 | 60 |
| Elongation at break [%] | 570 | 580 | 540 | 490 |
| Tear propagation | 76 | 80 | 82 | 103 |
| resistance [kN/m] | | | | |
| Abrasion [mm³] | 70 | 47 | 50 | 40 |
| T_{g} (DMA, max G″) | −30 | −30 | −30 | −25 |
| [° C.] | | | | |
| Blooming | no | no | no | no |
| Embrittlement at | no | no | no | no |
| about 0° C. | | | | |

### c) Examples 5-7

| Mechanical testing | Example 5 | Example 6 | Example 7 |
|---|---|---|---|
| Density [g/cm³] | 1.196 | 1.195 | 1.192 |
| Shore hardness test [A (D)] | 83 (36) | 82 (34) | 81 (34) |
| Tensile strength [MPa] | 56 | 52 | 59 |
| Elongation at break [%] | 550 | 590 | 600 |
| Tear propagation resistance [kN/m] | 76 | 80 | 83 |
| Abrasion [mm³] | 41 | 43 | 45 |
| T_{g} (DMA, max G″) [° C.] | −35 | −35 | −35 |
| Blooming | no | no | no |
| Embrittlement at about 0° C. | no | no | no |

### d) Examples 8-11

| Mechanical testing | Example 8 | Example 9 | Example 10 | Example 11 |
|---|---|---|---|---|
| Density [g/cm³] | 1.200 | 1.183 | 1.217 | 1.215 |
| Shore hardness test [A (D)] | 85 (42) | 93 (45) | 90 (49) | 87 (40) |
| Tensile strength [MPa] | 61 | 56 | 62 | 64 |
| Elongation at break [%] | 470 | 610 | 480 | 500 |
| Tear propagation resistance [kN/m] | 107 | 108 | 112 | 93 |
| Abrasion [mm³] | 35 | 26 | 37 | 36 |
| T_{g} (DMA, max G″) [° C.] | −15 | −30 | −20 | −20 |
| Blooming | no | no | no | no |
| Embrittlement at about 0° C. | no | no | no | no |

### d) Example 12

| Mechanical testing | Example 12 |
|---|---|
| Density [g/cm³] | 1.100 |
| Shore hardness test [A (D)] | 82 (32) |
| Tensile strength [MPa] | 49 |
| Elongation at break [%] | 650 |
| Tear propagation resistance [kN/m] | 50 |
| Abrasion [mm³] | 29 |
| T_{g} (DMA, max G″) [° C.] | −55 |
| Blooming | — |
| Embrittlement at about 0° C. | no |

### 7. Result

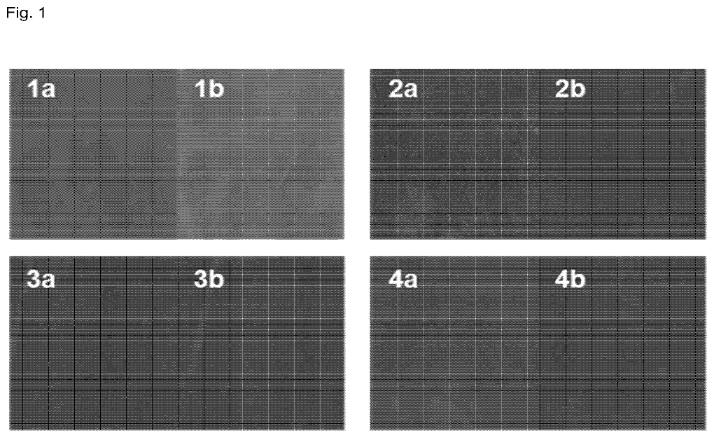

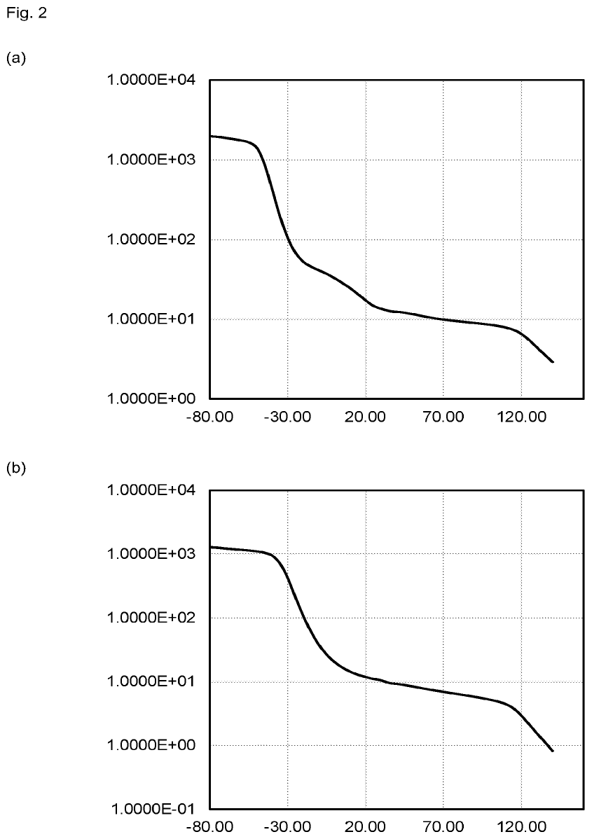

As apparent from the examples, the mechanical properties of all examples are comparable. Blooming is distinctly reduced by the use of polyester polyols having relatively low molecular weight (example 2, FIG. 1b) by comparison with a polyester polyol having higher molecular weight (example 1, FIG. 1a). In the case of use of a polyester polyol having relatively low molecular weight, however, there is also a significant decrease in cold flexibility, or a rise in glass transition temperature (example 2, table 1, FIG. 2a). Surprisingly, virtually no blooming is observed as a result of isocyanate modification of the polyester polyol of relatively low molar mass, but cold flexibility is distinctly improved (examples 3 and 4, table 1, FIG. 1c and FIG. 1d; FIG. 2b).

### CITED LITERATURE

WO 15/000722 A1
EP 0687695 A1
U.S. Pat. No. 8,790,763
WO 2012/173911 A1
US 2003/0036621
WO 2009/103767 A1
WO 2008/116801 A1
“Kunststoffhandbuch”, volume 7, “Polyurethane”, Carl Hanser Verlag, 3rd edition, 1993, chapter 3.1

1-15. (canceled)

16: A process for producing a polyurethane, comprising:
(i) reacting a polyol composition (PZ) comprising a polyol (P1) with a polyisocyanate composition (PIZ-1) comprising a polyisocyanate (I1) to obtain a hydroxyl-terminated prepolymer (PP1);
(ii) reacting the prepolymer (PP1) obtained in (i) with a polyisocyanate composition (PIZ-2) comprising a polyisocyanate (I2) and at least one chain extender (K1) to obtain a polyurethane (PU1),
wherein a molar ratio of the OH groups in the components of the polyol composition (PZ) to the isocyanate groups in the components of the polyisocyanate composition (PIZ-1) in the reaction in (i) is in the range from 1.3:1 to 10:1,
wherein the polyol (P1) has a number average molecular weight in the range of from 500 g/mol to 1200 g/mol, and
wherein the polyol (P1) is selected from the group consisting of polyesterpolyols.

17: The process according to claim 16, wherein a totality of the components of the polyol composition (PZ) has an average molecular weight in the range from 500 to 1500 g/mol.

18: The process according to claim 16, wherein a totality of the components of the polyol composition (PZ) has an average functionality in the range from 1.7 to 2.3.

19: The process according to claim 16, wherein the polyurethane is thermoplastic.

20: The process according to claim 16, wherein the prepolymer (PP1) has an average molecular weight in the range from 800 to 5000 g/mol.

21: The process according to claim 16, wherein the polyisocyanate (I1) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) and naphthalene 1,5-diisocyanate (NDI).

22: The process according to claim 16, wherein the polyisocyanate (I2) is selected from the group consisting of diphenylmethane 2,2′-, 2,4′- and 4,4′-diisocyanate (MDI), tolylene 2,4- and 2,6-diisocyanate (TDI), hexamethylene diisocyanate (HDI), 1-isocyanato-4-[(4-isocyanatocyclohexyl)methyl]cyclohexane (H12MDI) and naphthalene 1,5-diisocyanate (NDI).

23: The process according to claim 16, wherein the polyisocyanate (I1) is selected from aliphatic polyisocyanates and the polyisocyanate (I2) is selected from aromatic polyisocyanates.

24: The process according to claim 16, wherein the chain extender (K1) is selected from the group consisting of diols, diamines and water.

25: The process according to claim 16, wherein the reaction in (i) is conducted at a temperature in the range from 40 to 130° C.

26: A polyurethane obtained by a process comprising (i) and (ii):
reacting a polyol composition (PZ) comprising a polyol (P1) with a polyisocyanate composition (PIZ-1) comprising a polyisocyanate (I1) to obtain a hydroxyl-terminated prepolymer (PP1);
(ii) reacting the prepolymer (PP1) obtained in (i) with a polyisocyanate composition (PIZ-2) comprising a polyisocyanate (I2) and at least one chain extender (K1) to obtain a polyurethane (PU1),
wherein a molar ratio of the OH groups in the components of the polyol composition (PZ) to the isocyanate groups in the components of the polyisocyanate composition (PIZ-1) in the reaction in (i) is in the range from 1.3:1 to 10:1,
wherein the polyol (P1) has a number average molecular weight in the range of from 500 g/mol to 1200 g/mol, and
wherein the polyol (P1) is selected from the group consisting of polyesterpolyols.

27: The polyurethane according to claim 26, wherein the prepolymer (PP1) has an average molecular weight in the range from 800 to 5000 g/mol.

28: The polyurethane according to claim 26, wherein the polyisocyanate (I1) is selected from aliphatic polyisocyanates and the polyisocyanate (I2) is selected from aromatic polyisocyanates.

29: The polyurethane according to claim 26, wherein the polyurethane is thermoplastic.

30: A process for production of shaped bodies, adhesives, coatings, hoses, films, nonwoven articles or fibers, comprising employing a polyurethane obtained by the process according to claim 16.
